(19) United States
(12) Patent Application Publication
(10) Pub. No.: US 2018/0372664 A1
(43) Pub. Date: Dec. 27, 2018

(54) SELECTIVE LASER ETCHING OR ABLATION FOR FABRICATION OF DEVICES

(71) Applicant: KING ABDULLAH UNIVERSITY OF SCIENCE AND TECHNOLOGY, Thuwal (SA)

(72) Inventors: Ulrich BUTTNER, Thuwal (SA); Khaled Nabil SALAMA, Thuwal (SA); Christos SAPSANIS, Thuwal (SA)

(73) Assignees: KING ABDULLAH UNIVERSITY OF SCIENCE AND TECHNOLOGY, Thuwal (SA); KING ABDULLAH UNIVERSITY OF SCIENCE AND TECHNOLOGY, Thuwal (SA)

(21) Appl. No.: 15/741,451

(22) PCT Filed: Jul. 1, 2016
(86) PCT No.: PCT/IB2016/053989

§ 371 Date: Jan. 2, 2018

Related U.S. Application Data
(60) Provisional application No. 62/188,902, filed on Jul. 6, 2015.

(51) Int. Cl. G01N 27/22; B23K 26/362; B23K 26/40

(52) U.S. Cl. CPC G01N 27/223; B23K 2103/56; B23K 26/40; B23K 26/362

(57) ABSTRACT

Methods of fabricating devices vial selective laser etching are provided. The methods can include selective laser etching of a portion of a metal layer, e.g. using a laser light source having a wavelength of 1,000 nm to 1,500 nm. The methods can be used to fabricate a variety of features, including an electrode, an interconnect, a channel, a reservoir, a contact hole, a trench, a pad, or a combination thereof. A variety of devices fabricated according to the methods are also provided. In some aspects, capacitive humidity sensors are provided that can be fabricated according to the provided methods. The capacitive humidity sensors can be fabricated with intricate electrodes, e.g. having a fractal pattern such as a Peano curve, a Hilbert curve, a Moore curve, or a combination thereof.

### CROSS-REFERENCE TO RELATED APPLICATIONS

This application claims priority to, and the benefit of, co-pending U.S. provisional application entitled “SELECTIVE LASER ETCHING OR ABLATION FOR FABRICATION OF DEVICES” having Ser. No. 62/188,902, filed Jul. 7, 2015, the contents of which are incorporated by reference in their entirety.

### TECHNICAL FIELD

The present disclosure generally relates to fabrication methods for electronic devices and devices produced therefrom.

### BACKGROUND

The electronics industry continues to develop higher-function devices in more compact areas. The wet etching and reactive ion etching techniques currently used to fabricate many devices have several disadvantages. One aspect of current methods limits low-cost mass production of these devices and rapid prototyping of devices.

Current devices are typically formed from a wafer onto which films of various materials have been deposited. The wafer is thus a multilayer structure that includes layers of ceramic, i.e., metal oxides, such as alumina; metals, such as aluminum; metal nitrides; metal carbides; hard carbon films; cobalt alloys; and nickel phosphorous compounds. Other metal and dielectric films may also be present.

To laser etch a reactive, self-passivating metal such as aluminum, high laser powers are often used. However, these high powers can cause damage to underlying layers or cratering of the metal layer. Laser etching is thus difficult to perform with high powers for detailed device features or to fabricate smaller device features.

It is therefore an object of the present disclosure to provide improved methods of laser etching for the fabrication of low cost sensors and devices.

Of particular importance is the forming of capacitive structures, e.g. capacitor structures are often used in the design of sensors. They can be capacitive gas sensors capable of detecting changes in the concentration of a gas, for example water vapor, from a change in the capacitance in the sensor. Various designs have been developed to improve the capacitance. One approach for providing capacitance involves interleaving thin metal tracks on one layer. Owing to the shortcomings of these capacitor structures, there exists a need for a low cost capacitor structure that provides increased capacitance in a minimized space.

It is therefore an object of this disclosure to provide capacitive humidity sensors with small sizes, improved capacitance, and greater sensitivities.

### SUMMARY

In various aspects, methods of laser etching for the fabrication of electronic devices are provided and the devices fabricated therefrom. In certain aspects, capacitive humidity sensors with small sizes, improved capacitance, and greater sensitivities are provided that can be manufactured by the methods described herein.

Methods of manufacturing a device having at least a metal layer and substrate layer are provided. The methods can include selective laser etching of a portion of the metal layer, e.g. by exposing the portion of the metal layer to a laser light source having a wavelength of 1,000 nm to 1,500 nm. In various aspects, the laser light source can be a pulsed laser light source with a pulse energy less than 5 mJ. The laser light source can have a repetition frequency of 30 kHz to 500 kHz. In various aspects, the laser light source has an average power of less than 100 W.

The methods can be applied to a variety of substrates. In various aspects, the substrate layer has a transmittance of at least 80% at the wavelength of the laser light source. Substrates can include, for example, a material selected from a fabric, a paper, a polymer, a glass, a transparent conducting oxide, a carbon nanotube, and a combination thereof. In various aspects, the substrate layer is a synthetic paper selected from a polyamide, a polyester, a polypropylene, a polyacrylonitrile, a polyvinylchloride, co-polymers thereof, and combinations thereof. In various aspects, the substrate layer is a polymer selected from polyethylene terephthalate, high-density polyethylene, poly(methyl methacrylate), polyvinylchloride; co-polymers thereof, and combinations thereof. Although other thicknesses may be possible, in various aspects the substrate can have a thickness of 300 nm to 30 μm.

The methods can include depositing the metal layer onto the substrate layer prior to the laser etching step. In various aspects, the metal layer has an absorption of at least 0.05 a.u. at the wavelength of the laser light source. In various aspects, the metal layer includes a metal selected from Al, Ag, Au, Cr, Pt, Sn, Ti, Zn, and a combination thereof. The metal layer can be deposited at a variety of thicknesses. In various aspects, the metal layer has a thickness of 50 nm to 30 μm.

Various methods are provided wherein a portion of the metal layer is removed leaving one or more features in the metal layer. In various aspects, the features include an electrode, an interconnect, a channel, a reservoir, a contact hole, a trench, a pad, and a combination thereof. In various aspects, the features can have a width of 1 μm to 60 μm. In some aspects, the method includes leaving two or more features in the metal layer, e.g. separated by a distance of 1 μm to 100 μm.

In various aspects, the methods include encapsulating all or a portion of the device. The methods can be applied to generate a variety of devices. For example, in some embodiments a capacitive humidity sensor is provided fabricated by one or more of the methods provided herein.

Capacitive humidity sensors are provided. In various aspects, the capacitive humidity sensor includes (a) a flexible insulating substrate, (b) a first electrode disposed on the substrate; (c) a second electrode disposed on the substrate proximately arranged with respect to the first electrode to form a gap conductively isolating the first electrode from the second electrode; and (d) a permeable polymer layer disposed on at least a portion of the electrodes and the substrate.

The capacitive humidity sensor can include a variety of flexible substrate materials. In various aspects, the flexible substrate includes a material selected from a fabric, a paper, a polymer, and a combination thereof. The flexible substrate can be a synthetic paper, such as a polyimide, a polyester, a polypropylene, a polyacrylonitrile, a polyvinylchloride, co-polymers thereof, and combinations thereof. The flexible substrate can be a polymer; such as polyethylene terephthalate, high-density polyethylene, poly(methyl methacrylate), polyvinylchloride; co-polymers thereof, and combinations thereof.

The sensors can include a variety of electrode materials and dimensions. In various aspects, the first electrode, the second electrode, or both include a material selected from Ag, Au, C, Cr, Pt, and a combination thereof. The first electrode, the second electrode, or both can have a thickness of about 300-900 nm. In various aspects, the first electrode and the second electrode are interdigitated. For example, the first electrode can be arranged in a fractal pattern selected from the group consisting a Peano curve, a Hilbert curve, a Moore curve; and a combination thereof. The fractal pattern can have an order of 3 to 7.

The capacitive humidity sensor can be made having a small gap, e.g., wherein the gap is about 100 um. The permeable polymer layer can fill the gap between the first electrode and the second electrode. In various aspects, the water-permeable polymer layer includes a polymer selected from polyimide (PI), polyvinyl alcohol (PVA), carboxymethlycellulose (CMC), polyamides, polycaprolactone (PCL), polyethylene oxide (PEO), polysulfone (PSU), poly(etherimide) (PEI), polyimide (PI), polybenzimidazol (PBI), polystyrene (PS), polyurethanes (PU), poly(vinyl chloride) (PVC), poly(vinyl pyrrolidone) (PVP), poly(tetrafluoro ethylene) (PTFE), derivatives thereof, copolymers thereof, and combinations thereof. In various aspects, the permeable polymer layer includes an ionomer. The ionomer can include ionized pendant functional groups selected from a carboxylic acid group, a nitric acid group, and a sulfuric acid group. In various aspects, the ionized pendant functional groups are present on less than 25% of the repeat units of the ionomer.

Methods of making the capacitive humidity sensors are provided, e.g. according to one of the methods provided herein. In various aspects, the methods include (a) depositing the electrode material on the flexible substrate to form an electrode layer disposed on the substrate; (b) subtractive etching of the electrode layer to form the first electrode disposed on the substrate and the second electrode disposed on the substrate proximately arranged with respect to the first electrode; and (c) coating at least a porting of the electrodes and/or the substrate with the permeable polymer layer to form the capacitive humidity sensor. The etching can include maskless laser etching of the electrode layer to form the electrodes. The methods can include spin coating of the permeable polymer layer to form the capacitive humidity sensor.

Methods of measuring the relative humidity of a gas or air using the capacitive humidity sensors are also provided. In various aspects, the methods include (a) contacting the gas or air with a capacitive humidity sensor provided herein; and (b) measuring the capacitance of the humidity sensor, wherein the measured capacitance value is indicative of 2.0 the relative humidity of the gas or air. In various aspects, the methods can be applied, wherein a change of the relative humidity of 10% or less corresponds to a change in the measured capacitance of 0.01 pF or more.

Other systems, methods, features, and advantages of methods of fabricating a device and devices fabricated therefrom will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Further aspects of the present disclosure will be readily appreciated upon review of the detailed description of its various embodiments, described below, when taken in conjunction with the accompanying drawings.

FIG. 1A is a picture of a capacitive humidity sensor having gold electrodes in a Moore fifth-order Fractal structure patterned onto a flexible polyethylene terephthalate (PET) substrate, FIG. 1B is a picture of a capacitive humidity sensor having gold electrodes in an interdigitated structure patterned onto a flexible polyethylene terephthalate (PET) substrate. FIG. 1C is a picture demonstrating the flexibility of the capacitive humidity sensor depicted in FIG. 1B.

FIG. 2 is a schematic of a fabrication process for making a capacitive humidity sensor on a flexible substrate: (a) a bare polyethylene terephthalate (PET) sheet is used as a substrate; (b) a 600 nm Au layer is sputter coated onto the substrate at a rate of 59 nm/min; (c) features are formed in the Au layer using a maskless laser etching process; and (d) the surface is coated by spin coating a thin polymer layer (Nafion or Polyimide).

FIG. 3A is a schematic diagram of the testing setup for testing the capacitive humidity sensors using a test chamber containing a commercial humidity sensor (monitored by a multimeter) and the capacitive humidity sensor (monitored by an LCR meter) and a mixture of dry nitrogen gas and water vapor controlled by a pair of mass flow controllers (MFC). FIG. 3B is a photograph of a testing setup.

FIG. 4 is a graph of the capacitance (pF) as a function of the relative humidity (%) for capacitive humidity sensor having Au electrodes in a Moore fifth-order fractal geometry with a Nafion (rhombus) and a polyimide polymer layer (triangles).

FIG. 5 is a graph of the capacitance (pF) as a function of time (min) comparing the purge and ramp experiment described in Example 2 herein for capacitive humidity sensors with Au electrodes having a Moore fifth-order fractal geometry and a Nafion (upper curve) or a polyimide (lower curve) polymer coating.

FIGS. 6A-6D depict a fractal Peano curve to first (FIG. 6A), second (FIG. 6B), third (FIG. 6C), and fourth (FIG. 6D) order.

FIGS. 7A-7F depict a fractal Hilbert curve to first (FIG. 6A), second (FIG. 6B), third (FIG. 6C), fourth (FIG. 6D), fifth (FIG. 6E), and sixth (FIG. 6F) order.

FIGS. 8A-8F depict a fractal Moore curve to first (FIG. 6A), second (FIG. 6B), third (FIG. 6C), fourth (FIG. 6D), fifth (FIG. 6E), and sixth (FIG. 6F) order.

FIG. 9 is a photograph of a multilayer device with features created by selective laser etching of a Gold metal layer on a paper (“Teslin”) substrate.

FIG. 10 is a photograph of a multilayer device with features created by selective laser etching of an Aluminum metal layer on a polyethylene terephthalate (PET) substrate.

FIG. 11 is a photograph of a multilayer device with features created by selective laser etching of a Gold metal layer on a glass substrate.

FIG. 12 is a graph of the absorption spectra of various metals.

FIG. 13 is a graph of the transmittance spectra of polymer substrate materials PMMA, PVC, PC, and PET.

### DETAILED DESCRIPTION

Methods of manufacturing devices via selective laser etching or ablation are provided. The devices can have a single metal/conductive layer. The devices can be single layer circuit devices. The devices can be multilayer devices, for example having a substrate layer and a metal layer. The methods can include the selective laser etching of a metal layer on a substrate to create one or more features in the metal layer. The selective laser etching can be performed without damaging the substrate layer or without significantly changing the physical properties of the substrate layer. For example, the substrate layer can have a high transmittance at the wavelength of the laser light source, while the laser light is still capable of etching or removing a portion of the metal layer to create the features.

Capacitive humidity sensors on flexible substrates are provided. The capacitive humidity sensors can have electrodes proximately arranged with respect to each other and having a fractal or interdigitated arrangement on the substrate. This provides for high capacitance while maintaining small size and high degrees of flexibility. In some embodiments the electrodes are arranged in a fractal pattern such as a Peano curve, Hilbert curve, or Moore curve. The capacitive humidity sensors can have a flexible substrate. The sensor can have a permeable polymer layer that can fill a gap between the electrodes.

Methods of making capacitive humidity sensors are provided. The methods can include depositing a layer of an electrode material onto a substrate, and forming the electrode structure(s) in the layer of the electrode material. For example, the electrode structure(s) can be formed by subtractive etching procedures. The methods can include forming the electrode structure(s) via maskless laser etching of the electrode material layer. The methods can further include depositing a permeable polymer layer onto the electrodes and/or the substrate.

Methods of using capacitive humidity sensors are provided. Methods can include measuring a change in capacitance in response to the presence of water or to a change in the relative humidity in the vicinity of the sensor.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting. The skilled artisan will recognize many variants and adaptations of the embodiments described herein. These variants and adaptations are intended to be included in the teachings of this disclosure and to be encompassed by the claims herein.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

Although any methods and materials similar or equivalent to those described herein can also be used in the practice or testing of the present disclosure, the preferred methods and materials are now described. Functions or constructions well-known in the art may not be described in detail for brevity and/or clarity. Embodiments of the present disclosure will employ, unless otherwise indicated, techniques of nanotechnology, organic chemistry, material science and engineering and the like, which are within the skill of the art. Such techniques are explained fully in the literature.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In some embodiments, the term “about” can include traditional rounding according to significant figures of the numerical value. In addition, the phrase “about ‘x’ to ‘y’”, where ‘x’ and ‘y’ are numerical values, includes “about ‘x’ to about ‘y’”.

### Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

The terms “bendable” and “flexible”, as used interchangeably herein, refer to the ability of a material such as a metal, polymer, or blend; a structure, such as a substrate or electrode; or a device such as a sensor to be deformed into a curved or bent shape without undergoing a transformation that introduces significant strain, such as strain characterizing the failure point of a material, structure, or device. In some embodiments, a flexible material, structure, or device may be deformed into a curved shape without introducing strain larger than about 5%, 4%, 3%, 2%, or 1%. A variety of properties provide flexible structures (e.g., device components), including materials properties such as a low modulus, bending stiffness and flexural rigidity; physical dimensions such as small average thickness (e.g., about 200 microns, 100 microns, 75 microns, 50 microns, 25 microns, or less) and device geometries such as thin film and fractal geometries. In this description, a “bent configuration” refers to a structure having a curved conformation resulting from applying a force. Bent structures may have one or more folded regions, convex regions, concave regions, and any combinations thereof. Useful bent structures, for example, may be in a fractal arrangement, a coiled conformation, a wrinkled conformation, a buckled conformation and/or a wavy (i.e., wave-shaped) configuration.

The term “bending stiffness”, as used herein, is a mechanical property of a material, device or layer describing the resistance of the material, device or layer to an applied bending moment. Generally, bending stiffness is defined as the product of the modulus and area moment of inertia of the material, device or layer. A material having an inhomogeneous bending stiffness may optionally be described in terms of a “bulk” or “average” bending stiffness for the entire layer of material.

The term “stretchable”, as used, refers to the ability of a material, structure, device or device component to be strained without undergoing fracture. In some embodiments, a stretchable material, structure, device or device component may undergo strain larger than 0.5% without fracturing, for some applications strain larger than 1% without fracturing and for yet other applications strain larger than 3% without fracturing. A used herein, many stretchable structures are also flexible. Some stretchable structures (e.g., device components) are engineered to undergo compression, elongation and/or twisting to be able to deform without fracturing. Stretchable structures include thin film structures comprising stretchable materials, such as elastomers; bent structures capable of elongation, compression and/or twisting motion; and structures having an island—bridge geometry. Stretchable device components include structures having stretchable interconnects, such as stretchable electrical interconnects.

The term “substrate” refers to a material having a surface capable of supporting a structure, including an electronic device or electronic device component. A structure that is “disposed” on the substrate refers to a portion of the structure in physical contact with the substrate and unable to substantially move relative to the substrate surface on which it is disposed. A structure that is disposed on a substrate may be said to be “bonded” to the substrate, although this need not necessarily be conventional chemical covalent or ionic bonding, but also non-covalent Van der Waals or hydrophobic interactions.

The terms “Young's modulus” and “modulus”, as used interchangeably herein, refer to a mechanical property of a material, device or layer which refers to the ratio of stress to strain for a substance. Young's modulus may be provided by the expression;

$$E = \frac{( stress )}{( strain )} = ( \frac{{L}_{0}}{Δ L} ) ( \frac{F}{A} )$$

where, E is Young's modulus, L₀ is the equilibrium length, ΔL is the length change under the applied stress, F is the force applied and A is the area over which the force is applied. Young's modulus may also be expressed from Lame constants via the equation:

$$E = \frac{μ ( 3 λ + 2 μ )}{λ + μ}$$

where, λ and μ are Lame constants. High Young's modulus (or “high modulus”) and low Young's modulus (or “low modulus”) are relative descriptors of the magnitude of Young's modulus in a material, layer or device. In some embodiments, a high Young's modulus is larger than a low Young's modulus, preferably 10 times larger for some applications, more preferably 100 times larger for other applications and even more preferably 1000 times larger for yet other applications. “Inhomogeneous Young's modulus” refers to a material having a Young's modulus that spatially varies (e.g., changes with surface location). A material having an inhomogeneous Young's modulus may optionally be described in terms of a “bulk” or “average” Young's modulus for the entire layer of material. “Low modulus” refers to materials having a Young's modulus less than or equal to 10 MPa, less than or equal to 5 MPa, or optionally less than or equal to 1 MPa and optionally for some applications less than or equal to 0.1 MPa.

Methods of Manufacturing Devices

Methods of manufacturing devices are provided. The devices can be manufactured with low cost. The devices can be a single-layer circuit device, or a multi-layer device. The device can have a metal layer and a substrate layer. The methods can include selective laser etching of a portion of the metal layer. The methods can include selective laser ablation or laser etching. The term “laser etching”, as used herein, means the removal of portions of one or more layers in a multi-layer structure are removed via localized ablation, sublimation, or evaporation by exposure to a wavelength of light from a high-intensity light source such as a laser. The methods can include exposing a portion of the metal layer to a wavelength of light from a laser light source. The laser etching can include using a single laser light source and/or using a single wavelength of light. One or more layers can have a high transmittance at the wavelength of the laser light source. For example, the substrate can have a high transmittance at the wavelength of the laser light source while the metal layer can have a substantial absorbance at the wavelength of the laser light source.

Laser etching is said to be selective when laser etching removes one or more layers while leaving one or more layers, for example the substrate layer, relatively unaffected by the etching. The substrate layer can be relatively unaffected by the etching while the physical properties of the layer are relatively unchanged, e.g. the layer thickness is relatively unchanged, the flexural strength of the layer is relatively unchanged, the bending stiffness of the layer is relatively unchanged, the electrical conductivity of the metal layer being etched is changed to becoming non-conducting (high resistance), or a combination thereof. A physical property of the substrate is said to be relatively unchanged upon laser etching when the measured property changes by about 15%, 12%, 10%, 8%, 5%, 2%, 1%, or less relative to the measured property prior to the laser etching. In some embodiments that a layer is relatively unaffected by the etching can be seen by looking at the layer through an optical microscope or through a change in resistance as measured by a voltmeter.

The methods can include exposing a portion of the metal layer to a wavelength of light from a laser light source. The laser light source can have a wavelength of about 1,000 nm to 1,500 nm, about 1,020 nm to 1,500 nm, about 1,040 nm to 1,500 nm, about 1,040 nm to 1,400 nm, about 1,040 nm to 1,300 nm, about 1,040 nm to 1,250 nm, about 1,040 nm to 1,200 nm, or about 1,050 nm to 1,200 nm. In one or more aspects, the wavelength can be about 1,040 nm to about 1200 nm. The laser light source can have an average power of about 100 W, 80 W, 60 W, 50 W, 45 W, 40 W, 35 W, or less. In one or more aspects, the average laser light source can be around 40W.

The laser light source can be a pulsed laser light source. The pulsed laser light source can have a pulse energy of about 10 mJ, 8 mJ, 5 mJ, 4 mJ, 3 mJ, 2.5 mJ, 2.0 mJ, 1.8 mJ, or less. In one or more aspects, the pulse energy can be about 2 mJ. The pulsed laser light source can have a repetition frequency of about 10 kHz to 1,000 kHz, 10 kHz to 900 kHz, about 10 kHz to 800 kHz, about 20 kHz to 800 kHz, about 20 kHz to 700 kHz, about 30 kHz to 700 kHz, about 30 kHz to 600 kHz, about 30 kHz to 550 kHz, or about 30 kHz to 500 kHz. In one or more aspects, the pulse energy can be up to 250 kHz.

The Substrate Layer

The substrate layer can have a transmittance at the wavelength of the laser light source that is about 75%, 80%, 85%, 90%, 95%, 98%, 99%, 99.5% or greater. FIG. 13 is a graph of the transmittance spectra of polymer substrates PMMA, PVC, PC, and PET that, in some embodiments, can be used as substrates for selective laser etching. The substrate can be a fabric, a paper, a polymer, a glass, a transparent conducting oxide, or a combination thereof. The substrate can be flexible and/or bendable. In some embodiments the substrate is also biocompatible and/or biodegradable. Exemplary substrates include polymer substrates such as polyethylene terephthalate (PET), high-density polyethylene (HDPE), poly(methyl methacrylate) (PMMA), polydimethylsiloxane (PDMS).

The substrate can be a polymer substrate. Many types of polymer films have been used as substrates, for example in flexible electronics applications. For example, the polymer can be polyethylene such as polyethylene terephthalate (PET) or polyethylene naphthalate (PEN), a polyimide, high-density polyethylene (HDPE), poly(methyl methacrylate) (PMMA), polyvinylchloride (PVC), polydimethylsiloxane (PDMS), derivatives thereof, or copolymers thereof. The substrate can be a polymer blend substrate.

The substrate can be a glass substrate. For example, the substrate can be a silicate glass containing, in addition to silica, sodium oxide, lime, boric oxide, lead oxide, germanium oxide, or a combination thereof. The substrate can be an inorganic oxide, for example indium tin oxide (ITO), fluorine doped tin oxide (FTG), aluminum doped zinc oxide (AZO), or other transparent conducting oxide. The substrate can be a coated glass substrate, e.g. a glass substrate having a layer of transparent conducting oxide or a layer of transparent conducting polymer adhered thereto.

The substrate can have any thickness suitable for the specific substrate material and application. In some embodiments, the substrate remains flexible and/or stretchable. In some embodiments the substrate will have a thickness of about 100 um, 75 um, 50 μm, 25 μm, 10 μm, 1 μm, or less. The substrate layer can have a thickness of about 300 nm to 30 μm, 500 nm to 30 μm, 1,000 nm to 30 μm, 2 μm to 30 μm, 2 μm to 25 μm, 2 μm to 20 μm, 4 μm to 20 μm, or 4 μm to 10 μm. In one or more aspects, the thickness of the substrate layer can be in the range of about 80 μm to about 100 μm, in particular about 100 μm.

The Metal Layer

The device can have a metal layer. The metal layer can be adhered to the substrate layer. In some embodiments the methods include depositing a metal layer onto the substrate prior to the laser etching. Methods of metal deposition onto a substrate are generally known in the art. Methods can include chemical vapor deposition, atomic layer deposition, puled laser deposition, sputter coating, and the like. The metal layer can have any thickness necessary for the desired application. The metal layer can have a thickness of about 100 nm to 100 μm, about 100 nm to 50 μm, about 100 nm to 30 μm, about 300 nm to 30 μm, about 500 nm to 30 μm, about 500 nm to 25 μm, about 500 nm to 20 μm, about 1 μm to 20 μm, or about 2 μm to 20 μm.

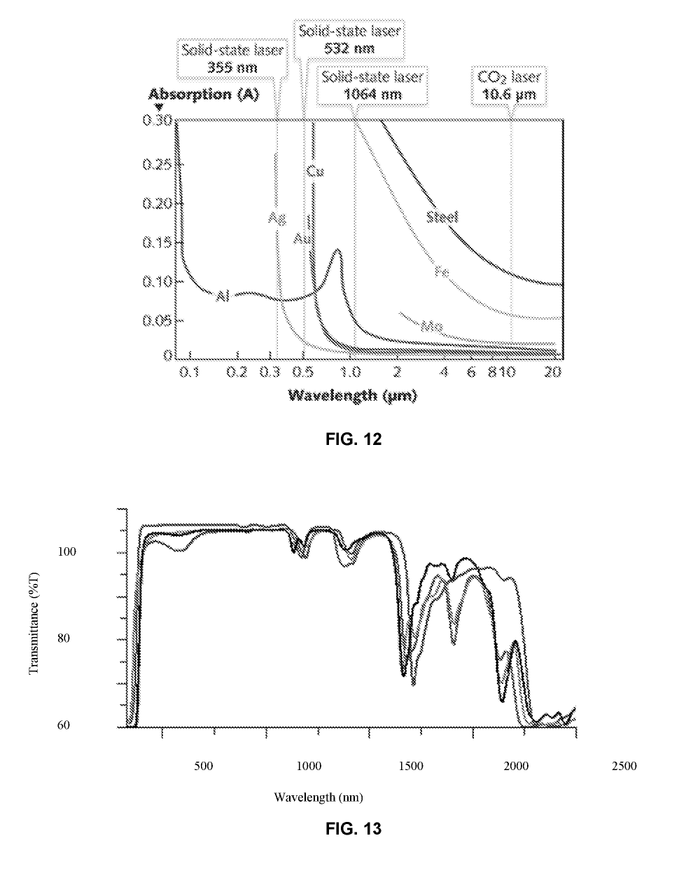

The metal layer or a portion of the metal layer can be removed by the laser etching, e.g. by localized ablation, sublimation, or evaporation upon exposure to the wavelength of light from the laser. The metal layer can have a large absorption of the wavelength of the laser light source. For example, the metal layer can absorb at least 30%, at least 40%, at least 50%, at least 60%, at least 70%, at least 80%, or at least 90% of the laser light. The metal layer can have an absorption of about 0.05 a.u., 0.1 a.u, 0.15 a.u, 0.2 a.u, 0.25 a.u, 0.3 a.u, 0.4 a.u, 0.5 a.u, 0.6 a.u, or greater at the wavelength of the laser light source. The metal layer can be chosen to have the appropriate absorption at the laser wavelength. FIG. 12 is a graph showing the absorption spectra of various metals that, in various embodiments, may be used to form the metal layer.

The metal layer can contain one or a plurality of different metals, e.g. the metal layer can be a layer of a single type of metal or can be a metal alloy, metal oxide, or the like. The metal layer can contain a metal selected from the group consisting of Al, Ag, Au, Cr, Pt, Sn, Ti, Zn, or a combination thereof. The metal layer can include metal oxides of the above.

Portions of the metal layer can be removed by the laser etching to create one or more features in the metal layer. The features can be used to create a variety of devices including single or multi-layer electronic device or microfluidic devices. The term feature can be used to refer to the portion of the metal layer that remains on the substrate after the laser etching or the portion on the substrate where the metal layer has been removed as will be clear from the context. For example, the laser etching can be used to create a metal electrode or an interconnect where the feature is the portion of the metal layer that is left to create the electrode structure, on the other hand the laser etching can be used to create a channel or a reservoir in a microfluidic device wherein the channel can be referred to as the feature. The features can include an electrode, an interconnect, a channel, a reservoir, a contact hole, a trench, a pad, and a combination thereof.

By controlling the focus of the laser light source, laser etching can be used to create detailed features on the metal layer. In some embodiments the features have a width of about 25 μm to 500 μm and above. The method can be used to make multiple features, for example at least 2, 3, 4, 5, 6, or 10 features can be made in the metal layer. The features can be separated by a distance of about 100 nm to 100 μm, about 100 nm to 50 μm, about 100 nm to 10 μm, about 100 nm to 1 μm, about 500 nm to 100 μm, about 1 μm to 100 μm, about 1 μm to 80 μm, about 1 μm to 60 μm, about 1 μm to 50 μm, about 2 μm to 50 μm, about 2 μm to 25 μm, or about 50 μm to 1000 μm.

Device Encapsulation

The methods can include encapsulating at least a portion of the device, or a portion of the metal layer, the features, or a combination thereof. Methods of device encapsulation are generally known and can range from dipping to spin casting as well as vapor deposition techniques. The encapsulation can include applying a polymer layer to at least a portion of the device, or a portion of the metal layer, the features, or a combination thereof. The polymer can be an impermeable polymer layer or a semi-permeable polymer layer. The polymer can include any of a variety of polymers as well as copolymers and blends thereof. The polymer layer can fill the gaps between the features in the metal layer. The permeable polymer layer can have any thickness, for example about 100 nm to 100 μm, about 100 nm to 50 μm, about 100 nm to 20 μm, about 100 nm to 10 μm, about 200 nm to 10 μm, about 200 nm to 5 μm, about 200 nm to 2 μm, about 500 nm to 2 μm, about 500 nm to 1 μm, or about 500 nm to 10 μm, nm.

The polymer can be a permeable polymer. The permeable polymer can be a polyimide (PI), polyvinyl alcohol (PVA), carboxymethlycellulose (CMC), polyamides, polycaprolactone (PCL), polyethylene oxide (PEO), polysulfone (PSU), poly(etherimide) (PEI), polyimide (PI), polybenzimidazol (PBI), polystyrene (PS), polyurethanes (PU), poly(vinyl chloride) (PVC), poly(vinyl pyrrolidone) (PVP), poly(tetrafluoro ethylene) (PTFE), derivatives thereof, copolymers thereof, or combinations thereof.

The permeable polymer layer can contain an ionomer. The term “ionomer”, as used herein, refers to a polymer that contains a small fraction of ionized repeat units, that are covalently bonded to the polymer backbone as pendant groups. For example, about 25%, 20%, 18%, 16%, 15%, 14%, 13%, 12%, 11%, 10%, or less of the repeat units in an ionomer contain ionized pendant groups. In some embodiments the ionomer has pendant acidic groups such as pendant sulfonic acid, carbonic acid, or nitric acid functional groups. The ionomer can be NAFION™, a sulfonated tetrafluoroethylene ionomer marketed by DuPont.

The polymer can be an impermeable polymer layer. For example, the polymer layer can be a fluorinated polymer that is impermeable to or repels moisture to prevent moisture from getting into the device.

Devices

The methods can be used to manufacture a variety of devices, including single-layer circuit devices, and multi-layer devices (such as a device having a metal layer and a substrate layer). The devices can be multilayer electronic devices such as a capacitor, a transistor, a diode, or the like. The devices can be microfluidic devices. In an exemplary embodiment described below the device is a capacitive humidity sensor.

The device can be manufactured with at least a substrate layer and a metal layer. The device can have one or a plurality of features, e.g. at least 2, 3, 4, 5, 6, or 10 features, on the metal layer. The features can be designed to give the device the intended function.

The methods can be used for rapid prototyping of devices. For example, a device architecture can be rapidly laser etched, the device can be tested, and the architecture of the device can be modified to improve performance characteristics as needed. This can be done quickly and inexpensively and with minimal modification using the methods provided herein.

Capacitive Humidity Sensors on Flexible Substrates

As a non-limiting example, the methods can be used to make capacitive humidity sensors. Capacitive humidity sensors on flexible substrates are provided. The sensors can be flexible and/or stretchable. Using inexpensive maskless laser etching to form the electrodes allows the electrode structures to be formed with small feature sizes and a large interfacial area. The capacitive humidity sensors can be inexpensive and disposable, while still having a high degree of durability and a high sensitivity to changes in relative humidity.

The capacitive humidity sensors can have many variations of the exemplary structures described herein, such as would be clear to one skilled in the art upon reading the present disclosure. In some embodiments the capacitive humidity sensor has a flexible substrate; a first electrode disposed on the substrate; and a second electrode disposed on the substrate proximately arranged with respect to the first electrode to form a gap. The term “proximately arranged”, as used herein, refers to the relationship between a pair of electrodes such that one electrode is very near the other in a way that shows a very close and direct relationship without a direct contact, e.g. immediately adjacent in space and separated by only a small distance such as about 100 μm, 75 μm, 50 μm, 25, 10

The capacitive humidity sensors can have a gap conductively isolating the first electrode from the second electrode. The second electrode can be proximately arranged with respect to the first electrode to form the gap. The gap can define an interfacial area, e.g. an area over which the second electrode is proximate to the first electrode and separated by a distance of about 100 μm, 75 μm, 50 μm, 25 μm, 10 μm, 1 μm, 900 nm, 800 nm, 700 nm, 600 nm, or less. The gap can be about 100 μm, 75 μm, 50 μm, 25 μm, 10 μm, 1 μm, 900 nm, 800 nm, 700 nm, 600 nm, or less. The gap can be filled with a dielectric such as a permeable polymer layer. In some embodiments the capacitive humidity sensor has a permeable polymer layer disposed on at least a portion of the electrodes and the substrate.

The sensors can have a capacitance that is sensitive to the presence of water or water vapor adjacent to or near the sensor surface, or to changes in the relative humidity in the vicinity of the sensor surface. By having small features and a large interfacial area, the capacitive humidity sensor can achieve high sensitivities to changes in relative humidity and/or low critical humidity levels. The term “critical humidity level”, as used herein, refers to the minimum humidity level above which a change in the relative humidity by an amount of about 10%, 5%, 2%, 1%, 0.5%, 0.1%, or less results in a measurable change in the capacitance, e.g. a change in capacitance of about 0.01 pF, 0.05 pF, 0.1 pF, 0.15 pF, or more. The capacitive humidity sensor can have a critical humidity level of about 70%, 65%, 60%, 55%, 50%, 45%, 40%, 35%, 30%, 25%, 20%, 10%, 5%, or less. The humidity sensors can therefore have a larger useful humidity range than other commonly available humidity sensors. For example, the humidity sensors can have a useful range of about 30%, 40%, 50%, 55%, 60%, 65%, 70%, 75%, or more.

Flexible Substrates

The capacitive humidity sensors can have a flexible substrate. While many flexible substrates may be envisioned, exemplary flexible substrates include fabrics, natural and synthetic papers, polymers, and combinations thereof. The flexible substrate can be flexible and/or bendable. In some embodiments the flexible substrate is also biocompatible and/or biodegradable material. Exemplary flexible substrates include polymer substrates such as polyethylene terephthalate (PET), high-density polyethylene (HDPE), poly(methyl methacrylate) (PMMA), and polyvinylchloride (PVC) and synthetic papers such as those marketed under the trade name TESLIN® by PPG Industries Ohio and those marketed under the trade name TYVEK® by DuPont.

The flexible substrate can be a fabric substrate. “Fabric”, as used herein, refers to a textile structure composed of mechanically interlocked fibers or filaments. The fibers may be randomly integrated (non-woven), closely oriented by warp and filler strands at right angles to one another (woven), or knitted. The term fabric encompasses both natural fabrics {i.e., fabrics formed from naturally occurring fibers) and synthetic fabrics {i.e., fabrics formed at least partially from one or more synthetic fibers), including, but not limited to cotton, rayon, wool, silk, and polyesters, as well as biodegradable fabrics containing polyhydroxyalkanoates (PHAs).

The flexible substrate can be a natural paper substrate. The term “natural paper”, as used herein, refers to a web of pulp fibers that are formed, for example, from an aqueous suspension on a wire or screen, and are held together at least in part by hydrogen bonding. Papers can be manufactured by hand or by machine. Paper can be formed from a wide range of matted or felted webs of vegetable fiber, such as “tree paper” manufactured from wood pulp derived from trees, as well as “plant papers” or “vegetable papers” which include a wide variety of plant fibers (also known as “secondary fibers”), such as straw, flax, and rice fibers. Paper can be formed from substantially all virgin pulp fibers, substantially all recycled pulp fibers, or both virgin and recycled pulp fibers. Paper may include adhesives, fillers, dyes, or other additives.

The flexible substrate can be a synthetic paper substrate. The term “synthetic paper”, as used herein, refers to plastic film and sheet products having a feel and printability similar to cellulose paper, e.g. paper-like laminar structures made in the form of thin sheets or films of synthetic resinous materials employed for various uses, such as writing and printing, as distinguished from natural cellulose paper. Synthetic papers can be made from polymers such as polyolefins, polyamides, polyesters, polypropylenes, polyacrylonitriles, polyvinylchloride, co-polymers thereof, and combinations thereof.

The substrate can be a polymer substrate. Many types of polymer films have been used as substrates in flexible electronics applications. For example, the polymer can be polyethylene such as polyethylene terephthalate (PET) or polyethylene naphthalate (PEN), a polyimide, high-density polyethylene (HDPE), polytetrafluoroethylene (PTFE), poly(methyl methacrylate) (PMMA), polyvinylchloride (PVC), polymethylsiloxane (PDMS), derivatives thereof, or copolymers thereof. The substrate can be a polymer blend substrate.

The flexible substrate can have any thickness suitable for the specific substrate material and application, so long as the substrate remains flexible and/or stretchable. In some embodiments the substrate will have a thickness of about 100 μm, 90 μm, 80 μm, 60 μm, 50 μm, 25 μm, 10 μm, 1 μm, or less.

Electrodes

The capacitive humidity sensor will have a number of electrodes, typically 2, although sensors with 3, 4, 5, 6, 7, 8, or more electrodes are also envisioned. The electrodes can be made sufficiently thin to maintain the desired flexibility of the sensor once disposed onto the substrate surface. In some embodiments the capacitive humidity sensor will have a first electrode disposed on the substrate and a second electrode disposed on the substrate and proximately arranged with respect to the first electrode.

The electrodes can be patterned in any suitable geometry on the substrate surface, although geometries with high degrees of edginess are preferred. The “edginess” of the electrode, as used herein, refers to any measure of the surface area relative to the overall size of the electrode and can be, for example, the ratio of the surface area to the volume or even the ratio of the perimeter to the area for a 2D projection of the electrode onto the substrate surface. Electrodes with a high degree of edginess allow for large area interfaces that increase capacitance while maintaining an overall smaller total space. This can allow for the flexible capacitive humidity sensors to maintain small size with high moisture sensitivities.

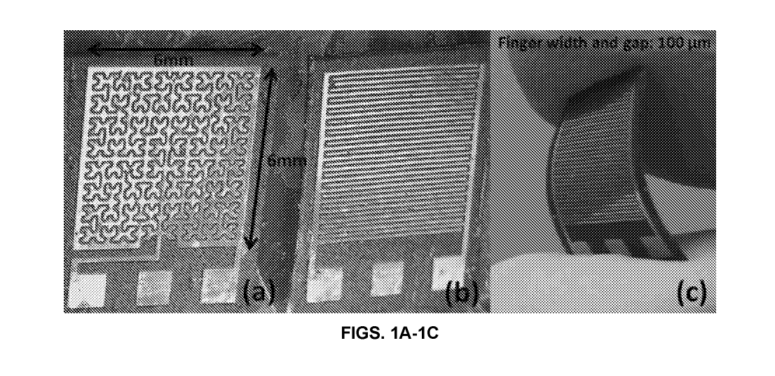

The electrodes can be interdigitated, e.g. the first electrode and the second electrode can be interdigitated. The term “interdigitated”, as used herein, describes two complementarily-shaped electrodes, wherein “branches” or “fingers” of each electrode are disposed in an alternating fashion. As shown in FIG. 1B, interdigitated electrodes are patterned to increase the length of the interface between the two electrodes, for example by forming multiple fingers which are arranged in an alternating fashion with respect to one another. Other interdigitated electrode shapes, in addition to the shapes illustrated in FIG. 1B, may also be suitable for capacitive humidity sensors.

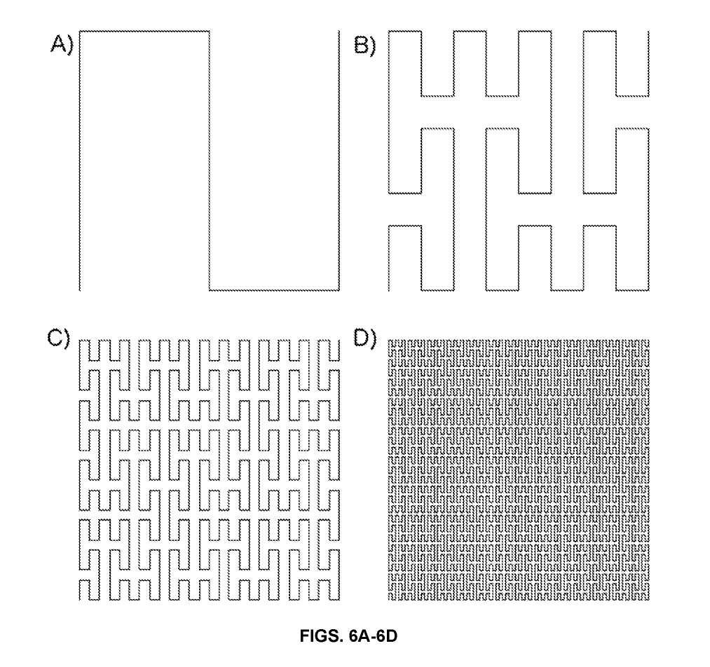

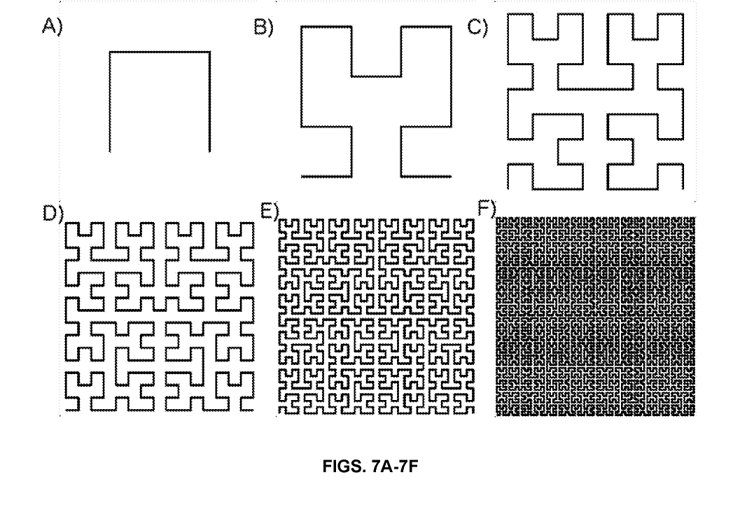

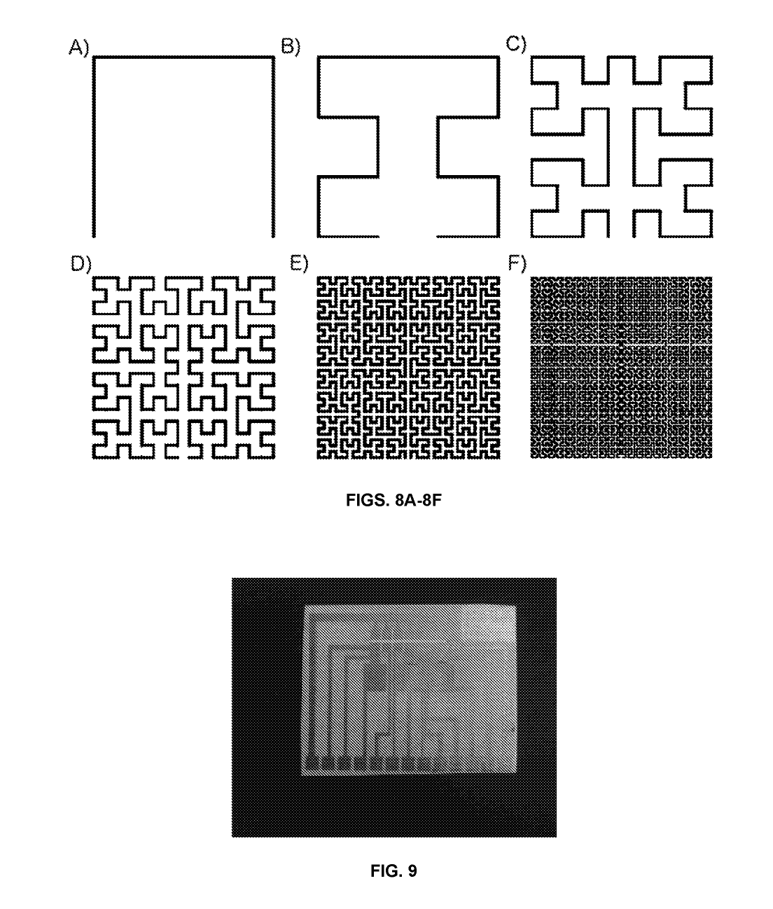

The electrodes can be arranged in a fractal pattern. Fractal patterns describe physical or geometrical shapes that form a repeating geometric pattern that in theory infinitely repeats over different size scales, but in practice are limited by the sizes of the material features. The terms “order and “iteration” are used interchangeably herein to refer to the number of times the fractal pattern repeats, i.e. the number of size scales over which the geometric pattern is repeated. In some embodiments the fractal pattern has an order of about 1 to 10, 2 to 10, 2 to 8, 2 to 7, 3 to 7, 3 to 6; or 3 to 5. The fractal pattern can be a Peano curve, a Hilbert curve, or a Moore curve. A capacitive humidity sensor is depicted in FIG. 1A where the first electrode is a Moore curve to fifth order and the second electrode is proximately arranged with respect to the first electrode. The first electrode can be arranged in a Peano curve, a Hilbert curve, a Moore curve, or a Vicsek curve of any order, e.g. having an order of 1, 2, 3, 4, 5, or more. The second electrode can be proximately arranged with respect to the first electrode. The electrode can be arranged in a Peano curve with an order of 1 to 4 as depicted in FIGS. 6A-6D. The electrode can be arranged in a Hilbert curve with an order of 1 to 6 as depicted in FIGS. 7A-7F. The electrode can be arranged in a Moore curve with an order of 1 to 6 as depicted in FIGS. 8A-8F.

The electrodes can be made from any material that has a suitable conductivity to be used as an electrode and that can be adhered to or deposited on the substrate surface. The electrode material can be a metal electrode such as Ag, Au, Cr, Pt, or combinations thereof and also conductive Carbon (C). The electrodes can be made from a metal layer deposited on the substrate surface. The electrodes and/or the metal layer from which the electrodes are formed can have a thickness of about 5 μm, 2, μm, 1, μm, 900 nm, 800 nm, 700 nm, 600 nm, 500 nm, 400 nm, or less. For example, the electrodes can have a thickness of about 100 to 1,500 nm, 100 to 1,200 nm, about 200 to 1,200 nm, about 200 to 1,000 nm, about 300 to 1,000 nm, about 300 to 900 nm, about 300 to 800 nm, about 400 to 800 nm, or about 500 to 700 nm.

Permeable Polymer Layer

The capacitive humidity sensor can have a permeable polymer layer. The permeable polymer layer can fill the gap between the first electrode and the second electrode. The permeable polymer layer can have any thickness, for example about 100 nm to 10 μm, about 200 nm to 10 μm, about 200 nm to 5 μm, about 200 nm to 2 μm, about 500 nm to 2 μm, about 500 nm to 1 μm, or about 500 nm to 800 nm.

The permeable polymer layer can include any of a variety of polymers as well as copolymers and blends thereof. The permeable polymer can be a polyimide (PI), polyvinyl alcohol (PVA), carboxymethlycellulose (CMC), polyamides, polycaprolactone (PCL), polyethylene oxide (PEO), polysulfone (PSU), poly(etherimide) (PEI), polyimide (PI), polybenzimidazol (PBI), polystyrene (PS), polyurethanes (PU), poly(vinyl chloride) (PVC), poly(vinyl pyrrolidone) (PVP), poly(tetrafluoro ethylene) (PTFE), derivatives thereof, copolymers thereof, or combinations thereof.

The permeable polymer layer can contain an ionomer. The term “ionomer”, as used herein, refers to a polymer that contains a small fraction of ionized repeat units that are covalently bonded to the polymer backbone as pendant groups. For example, about 25%, 20%, 18%, 16%, 15%, 14%, 13%, 12%, 11%, 10°/b, or less of the repeat units in an ionomer contain ionized pendant groups. In some embodiments the ionomer has pendant acidic groups such as pendant sulfonic acid, carbonic acid, or nitric acid functional groups. The ionomer can be NAFION™ a sulfonated tetrafluoroethylene ionomer marketed by DuPont.

Methods of Making Capacitive Humidity Sensors

In an aspect, among others, the device can be a capacitive humidity sensor, and methods of making capacitive humidity sensors are provided. The methods can include any of a variety of ways of forming the electrodes on a flexible substrate. The methods can include standard methods of photolithography. The methods can include depositing a layer of the electrode material onto the substrate followed by subtractive etching to form the electrodes. The methods can include forming the electrode structure on the substrate surface, for example forming the interdigitated structure or forming the fractal structure of the electrode.

The methods can include depositing a layer of the electrode material onto the substrate. The depositing step can include any of the conventional sputter deposition techniques, e.g. DC sputtering, RF sputtering, or magnetron sputtering. The methods can further include subtractive etching to remove part of the electrode material layer to form the electrode(s). In some embodiments the methods include maskless laser etching. The laser can have an output wavelength of about 1000 nm to 1300 nm, about 1020 nm to 1250 nm, about 1040 nm to 1200 nm, or about 1050 nm to 1150 nm. The laser can be a pulsed laser with a repetition frequency of about 10 kHz to 1000 kHz, about 20 kHZ to 800 kHz, about 30 kHz to 600 kHz, or about 50 kHz to 500 kHz. The laser pulse energy can be about 4 mJ, 3 mJ, 2 mJ, 1.5 mJ, 1 mJ, or less with an average power of about 60W, 50W, 40W, or less.

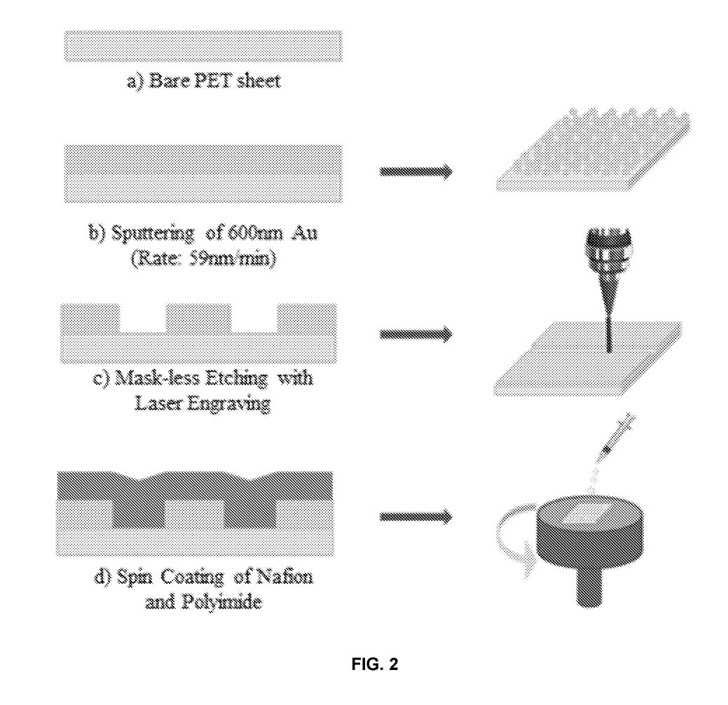

An exemplary subtractive fabrication process for making capacitive humidity sensors on flexible substrates is illustrated in FIG. 2. A substrate sheet can be provided in a first step (a). As described above the substrate material can be a flexible material, for example a flexible polyethylene terephthalate (PET) substrate. In step (b) an electrode material can be DC sputtered onto the flexible substrate to form a layer, for example about 600 nm thick. The electrode material can be, for example gold. Then, in step (c) the structures can be patterned allowing for rapid prototyping using a maskless laser etching. The last step (d) can be spin coating the polymer film(s).

The methods can include coating all or a part of the electrodes and/or substrate with a permeable polymer layer. The methods can include any method of polymer coating or polymer deposition. The methods can include spin coating of the permeable polymer onto at least a portion of the electrode and substrate. The methods can include spin coating the permeable polymer into the gap between the first electrode and the second electrode. The spin coating can include a spin rate of about 500 rpm to 5,000 rpm, about 500 rpm to 4,000 rpm, or about 1,000 rpm to 3,500 rpm for a period of time about 5 sec, 10 sec, 20 sec, 30 sec, or more.

Methods of Using Capacitive Humidity Sensors

Methods of using capacitive humidity sensors are provided. The methods can include placing the humidity sensor into a moist gas or moist air and measuring a change in capacitance in the senor that is indicative of the relative humidity of the gas or air. The methods can include measuring the relative humidity in a range of about 0% to 100%, about 5% to 95%, about 10% to 95%, about 10% to 90%, about 20% to 90%, or about 30% to 90%. The methods can include measuring the relative humidity at a temperature of about −100° C. to 300° C., about −100° C. to 250° C., about −80° C. to 250° C., about −80° C. to 200° C., or about −80° C. to 150° C., The methods can include detecting a change in capacitance of the humidity sensor in response to a change in the relative humidity in the vicinity of the sensor. The methods can include measuring a change in the capacitance of the humidity sensor of about 0.01 pF, 0.05 pF, 0.1 pF, 0.15 pF, or more in response to a change of about 10%, 5%, 2%, 1%, 0.5%, 0.1%, or less in the relative humidity.

### Examples

Now having described the embodiments of the present disclosure, in general, the following Examples describe some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure.

Fabrication of Exemplary Devices

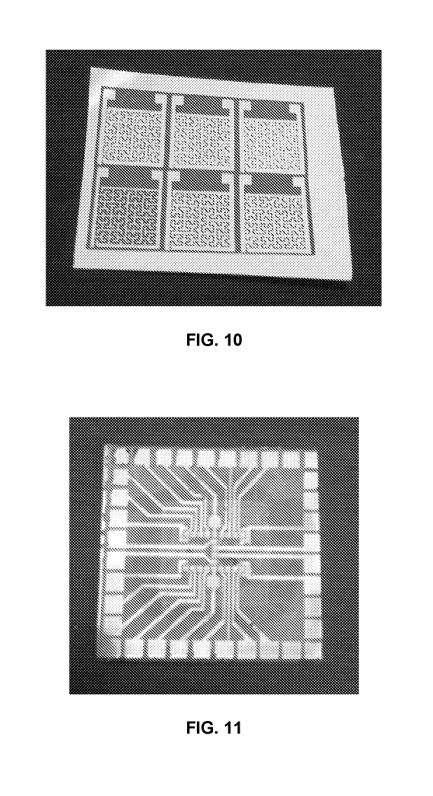

A variety of devices can be fabricated via methods disclosed herein. FIG. 9 depicts an exemplary embodiment of a device with features created by selective laser etching of a gold metal layer on a Teslin substrate. FIG. 10 depicts another exemplary device created by selective laser etching of an Aluminum metal layer on a polyethylene terephthalate (PET) substrate. FIG. 11 depicts a device created by selective laser etching a device on a glass substrate, here with a Gold metal layer.

Fabrication of Capacitive Humidity Sensors on Flexible Substrates

The capacitive humidity sensors were fabricated on flexible polyethylene terephthalate (PET) substrates. The subtractive fabrication process, which is illustrated in FIG. 2, starts with providing the substrate and DC sputtering of a gold layer for the electrodes onto the substrate. The electrode structures were patterned into the gold layer using a maskless laser etching process (Laser wavelength: 1040-1200 nm; max pulse energy <2 mj; Repetition frequency: 30 kHz −500 kHz; Max. avg. power˜40W).

The electrodes were coated by spin-coating thin polymer films, as explained in Table 1.

TABLE 1
Polymer Films preparation

| Material | PI | Nafion |
|---|---|---|
| Spin Rate | 500 rpm for 5 sec | 500 rpm for 5 sec |
| | 3500 rpm for 30 sec | 1000 rpm for 30 sec |
| Annealing | 90° C. for 90 sec | No |

Testing of Capacitive Humidity Sensors

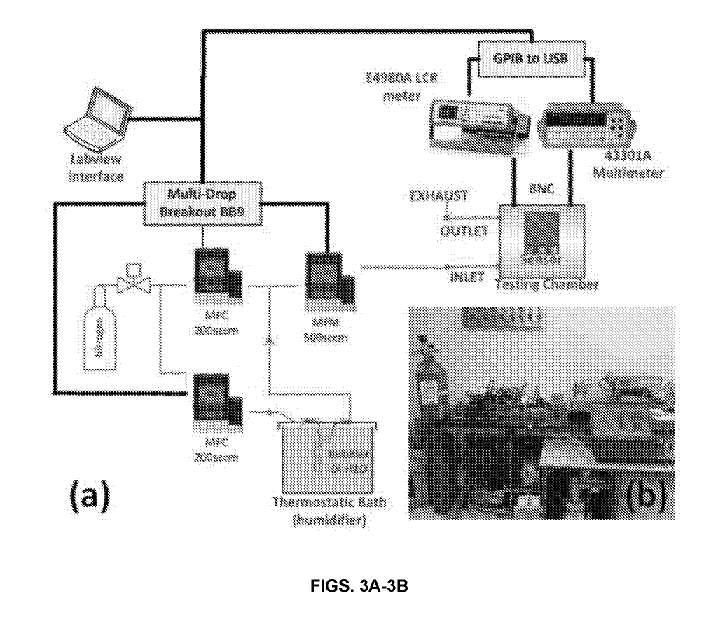

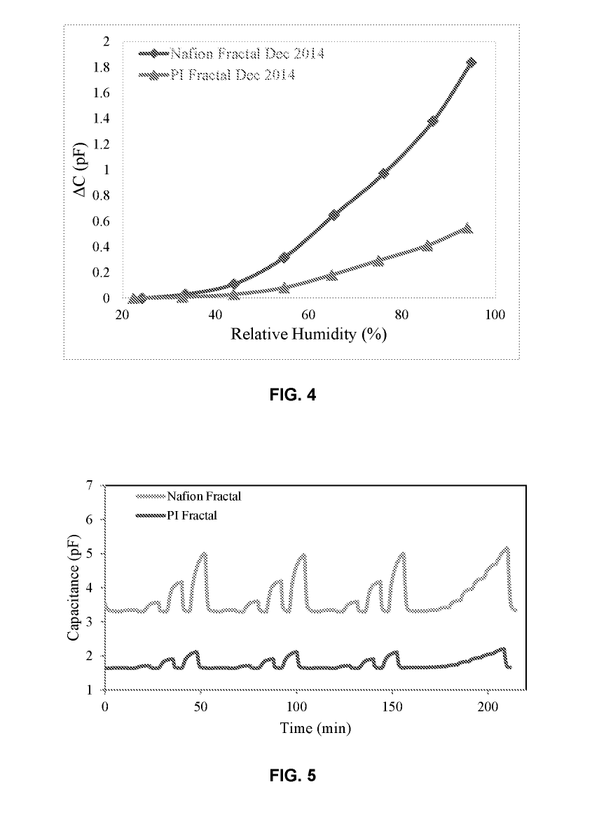

Humidity testing is important for showing the stability of a film. The experiments were conducted in a fully automated gas setup using LabVIEW, shown in FIG. 3. Two paths are employed; dry N₂ for diluting and a carrier gas to generate water vapor, through an immersed bubbler in a chiller. The testing chamber encompasses two humidity sensors; a commercial (Honeywell) and the sensor under test, with their values to be monitored by a 2.5 Multimeter and a LCR respectively. The flow of the gas is controlled and measured by Mass Flow Controllers (MFCs). Two types of experiments were conducted, ramp and purge, as shown in FIG. 4 and explained in Table 2. For the illustrated ramp experiment the final value is marginally higher since it corresponds to a slightly higher humidity level than in the purge cycle.

TABLE 2
Experiments process

| | | |
|---|---|---|
| Experiment | Purge | Ramp |

| | |
|---|---|
| Process | Dry N₂ from 200 to 0 and Vapor Carrier |
| | from 0 to 200 for 5% to 95% RH |

| | | |
|---|---|---|
| Purging | Yes | No |
| Step size (sccm) | 50 | 25 |
| Step time (min) | 8 | 6 |

| | |
|---|---|
| Temperature | Chiller: 17° C., Ambient: 20° C. |

The de-embedded results are concluded in Table 3 and depicted in FIG. 5. The fractal structure achieves a higher range compared to the IDEs, due to a higher initial capacitance value. Moreover, the Nafion, due to its hydrophilic nature, outperforms the PI, a highly dense material, in the overall humidity range. In all cases, it has been noticed that their behavior follows a second polynomial order with the critical level of humidity at approximately 55%, where a considerable increase in the range is achieved. For Nafion, the increase after this point is more compared to PI, proving again Nafion's hydrophilicity.

TABLE 3
Relative humidity range, sensitivity and operation equation of sensors.

| | Humidity | Sensitivity | Equation | |
|---|---|---|---|---|
| Film | Range | (fF/RH) | RH (x)-Capacitance (y) | R² |
| Nafion | 11%-65% | 15.7 | y = 0.0005x² − 0.0263x + | 0.998 |
| | | | 0.3738 | |
| | 65%-95% | 40.3 | y = 0.0399x − 2.0116 | 0.983 |
| Polyimide | 10%-65% | 4.3 | y = 0.0001x² − 0.0079x + | 0.992 |
| | | | 0.1123 | |
| | 65%-92% | 12.6 | y = 0.0124x − 0.6322 | 0.992 |

Both films achieve fast response/recovery time, as shown in FIG. 4, with Nafion being faster, following almost simultaneously any changes in humidity in the testing chamber, which requires 2-3 min to reach a 10% from 90%.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. A method of manufacturing a device having at least a metal layer and substrate layer, the method comprising selective laser etching of a portion of the metal layer.

2. The method of claim 1, wherein the selective laser etching step comprises exposing the portion of the metal layer to a laser light source having a wavelength of 1,000 nm to 1,500 nm.

3. The method of claim 2, wherein the laser light source is a pulsed laser light source with a pulse energy less than 5 mJ.

4. The method of claim 3, wherein the pulsed laser light source has a repetition frequency of 30 kHz to 500 kHz.

5. The method of claim 1, wherein the laser light source has an average power of less than 100 W.

6. The method of claim 1, wherein the substrate layer has a transmittance of at least 80% at the wavelength of the laser light source.

7. The method of claim 1, wherein the substrate layer comprises a material selected from the group consisting of a fabric, a paper, a polymer, a glass, a transparent conducting oxide, a carbon nanotube, and a combination thereof.

8. The method of claim 1, wherein the substrate layer is a synthetic paper selected from the group consisting of a polyamide, a polyester, a polypropylene, a polyacrylonitrile, a polyvinylchloride, co-polymers thereof, and combinations thereof.

9. The method of claim 1, wherein the substrate layer is a polymer selected from the group consisting of polyethylene terephthalate, high-density polyethylene, poly(methyl methacrylate), polyvinylchloride; co-polymers thereof, and combinations thereof.

10. The method of claim 1, wherein the substrate layer has a thickness of 300 nm to 30 μm.

11. The method of claim 1, comprising depositing the metal layer onto the substrate layer prior to the laser etching step.

12. The method of claim 1, wherein the metal layer has an absorption of at least 0.05 a.u. at the wavelength of the laser light source.

13. The method of claim 1, wherein the metal layer comprises a metal selected from the group consisting of Al, Ag, Au, Cr, Pt, Sn, Ti, Zn, and a combination thereof.

14. The method of claim 1, wherein the metal layer has a thickness of 50 nm to 30 μm.

15. The method of claim 1, wherein the portion of the metal layer is removed leaving one or more features in the metal layer.

16. The method of claim 15, wherein the features are selected from the group consisting of an electrode, an interconnect, a channel, a reservoir, a contact hole, a trench, a pad, and a combination thereof.

17. The method of claim 15, wherein the features have a width of 1 μm to 60 μm.

18. The method of claim 15, comprising leaving two or more features in the metal layer separated by a distance of 1 μm to 100 μm.

19. The method of claim 1, further comprising encapsulating at least a portion of the device.

20. A device manufactured according to claim 1.

21-40. (canceled)
